(19) United States
(12) Patent Application Publication
(10) Pub. No.: US 2023/0115542 A1
(43) Pub. Date: Apr. 13, 2023

(54) PROGRAMMABLE MATRIX MULTIPLICATION ENGINE

(71) Applicant: Intel Corporation, Santa Clara, CA (US)

(72) Inventors: Sridhar SR, Bangalore (IN); Tarjinder Singh, Bangladore (IN); Jagan Jeyaraj, Bangalore (IN); Fifi C., Bangalore (IN); Ankit Yadav, Bangalore (IN); Rishabh Kundu, Bangalore (IN)

(21) Appl. No.: 18/061,142

(22) Filed: Dec. 2, 2022

(51) Int. Cl. G06F 17/16

(52) U.S. Cl. CPC G06F 17/16

(57) ABSTRACT

Systems and methods include technology that divides first data associated with a first matrix into first multiplication tiles based on a block size that is identified based on an available space of a memory of an accelerator, and second data associated with a second matrix into second multiplication tiles based on the block size. The technology divides the first multiplication tiles into a plurality of first groups that correspond to a plurality of matrix multiplication operations and the second multiplication tiles into a plurality of second groups that correspond to the plurality of matrix multiplication operations. The technology loads a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

### TECHNICAL FIELD

Examples generally relate to grouping data for efficiency during compute operations. In particular, examples hierarchically block matrices for bandwidth, latency and compute (e.g., matrix multiplication) efficiency.

### BACKGROUND

General Matrix Multiply (GEMM) is a commonly used linear algebra operator. GEMM is a building block of several Deep Neural Network operations like convolutional neural network (CNN), Graph Neural Networks (GNN), Long short-term memory (LTSM) etc. The computations involved in GEMM are dense. For cases, where accelerators have a local memory (e.g., static random-access memory (SRAM)), whose size is limited in comparison to the actual size of the matrix, smaller blocks of matrices may be stored in the SRAM while computed results are stored back. The data transfer overhead may be costly however, particularly as the number of evictions from the local memory and retrievals for the local memory increases. The data transfer overhead may in turn negatively impact compute time due to stalls and/or waiting.

### BRIEF DESCRIPTION OF THE DRAWINGS

The various advantages of the embodiments will become apparent to one skilled in the art by reading the following specification and appended claims, and by referencing the following drawings, in which:

FIG. 1 is an example of a matrix multiplication architecture according to an embodiment;

FIG. 2 is a flowchart of an example of a method of general matrix multiply operations according to an embodiment;

FIG. 3 is an example of a matrix multiplication operation according to an embodiment;

FIG. 4 is an example of a block diagram of a hardware architecture according to an embodiment;

FIG. 5 is an example of a boundary conditions according to an embodiment;

FIG. 6 is an example of a program for processing matrices according to an embodiment;

FIG. 7 is an example of a memory slots for loading matrix data according to an embodiment;

FIG. 8 is an example of an interleaved load process according to an embodiment;

FIG. 9 is an example of a zig-zag load pattern according to an embodiment;

FIG. 10 is an example of a general matrix multiply operation architecture according to an embodiment;

FIG. 11 is an example of a general matrix multiply computing architecture according to an embodiment;

FIG. 12 is an example of an instruction set architecture according to an embodiment;

FIG. 13 is a diagram of an example of an matrix-multiplication enhanced computing system according to an embodiment;

FIG. 14 is an illustration of an example of a semiconductor apparatus according to an embodiment;

FIG. 15 is a block diagram of an example of a processor according to an embodiment; and

FIG. 16 is a block diagram of an example of a multi-processor based computing system according to an embodiment.

### DESCRIPTION OF EMBODIMENTS

Examples as described herein provide a highly efficient and configurable GEMM accelerator and data hierarchy that enhances artificial intelligence (AI) applications (e.g., Neural Network applications) and architectures by reducing latency, transfer overhead and compute time. For matrix multiplication operations that execute with a limited on-chip memory, data transfer methods determine compute efficiency, bandwidth requirement and latency of compute. Thus, examples as described herein provides enhanced data transfers by hierarchically breaking down (hierarchical blocking) matrices.

For example, in order to facilitate low bandwidth, reuse of data, and memory utilization to enhance matrix multiplication operation and machine learning based technological fields, examples divide first data associated with a first matrix into first multiplication tiles based on a block size that is identified based on an available space of a memory of an accelerator, and second data associated with a second matrix into second multiplication tiles based on the block size. The examples further divide the first multiplication tiles into a plurality of first groups that correspond to a plurality of matrix multiplication operations and the second multiplication tiles into a plurality of second groups that correspond to the plurality of matrix multiplication operations. Yet further, the examples load a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

As noted, matrices are hierarchically blocked for bandwidth, latency and compute efficiency. A first (e.g., top) level of blocking may be referred to as hypertiles. The hypertiles may correspond to an amount of accelerator bandwidth. A second level (may be referred to as groups or stripes) determines compute latency and efficiency of the accelerators. Groups also facilitate prefetching for a next operation (e.g., a next hypertile based operation). Interleaving the loading of groups from different matrices keeps efficiency high even in bandwidth constrained systems. The third level referred to as sub-tiles ensures compute efficiency in certain accelerators (e.g., a systolic array) as sub-tiles is the lowest unit of data transfer/computation. One hypertile of each of a first matrix (e.g., matrix A) and second matrix (matrix B) are required for the accelerator to provide and output a resultant output hypertile. Thus, a hypertile comprises a plurality of groups, and each group comprises a plurality of sub-tiles. Each group may only contain data for one matrix multiplication operation to enhance memory organization and stalls.

Furthermore, examples include a systolic array based GEMM engine. The systolic array engine connects to a dedicated unified memory (e.g., a SRAM, or unified SRAM which may be referred to as a SA_SRAM) that hosts part of matrices to be multiplied (e.g., A and B matrices) and the resulting matrix partition (e.g., matrix C) as well. The sizing of matrices A, B and C is designed to maximize re-use of data from the matrices A and B to be multiplied and hence reduces bandwidth due to lowered evictions and data transfers. A software based GEMM Compiler (GEMMC) may identify sizes of the tiles and translates the workload into a set of instructions. Furthermore, some examples reduce latency by hiding data transfer time by loading data from matrices A and B in an interleaved fashion.

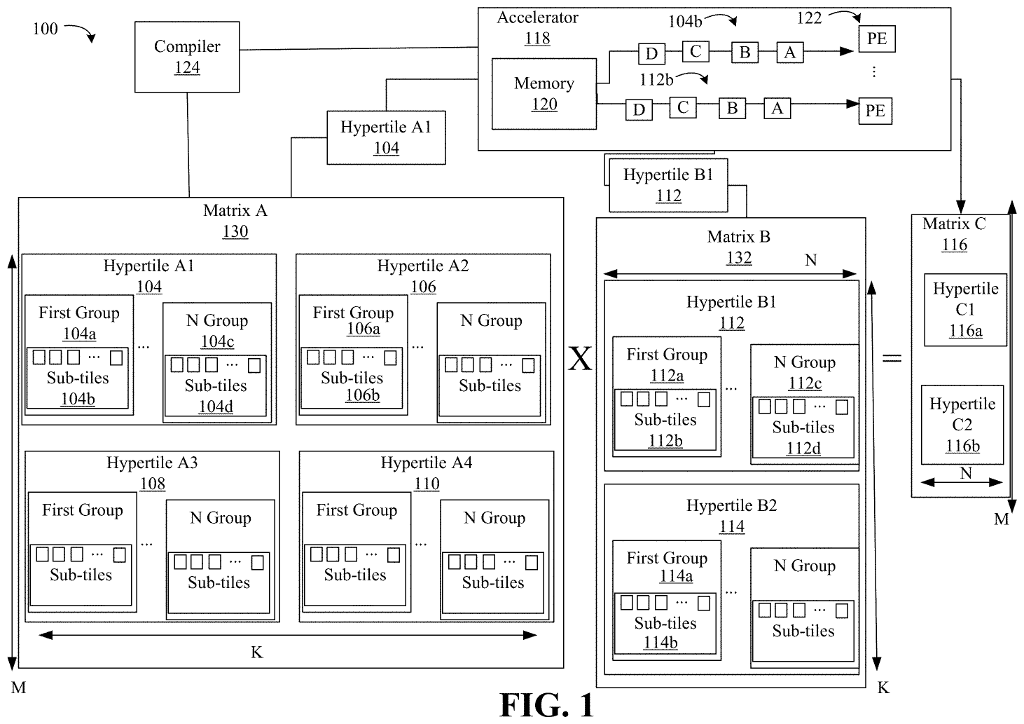

Turning now to FIG. 1, a matrix multiplication architecture 100 is illustrated. The matrix multiplication architecture 100 executes a matrix multiplication operation with the accelerator 118 on matrix A (e.g., a first matrix) and matrix B (e.g., a second matrix).

In this example, matrix A 130 and matrix B 132 are input matrices that are to be multiplied together to generate matrix C 116. The matrix multiplication operation (e.g., GEMM) may be provided by equation 1 below:

C=αAB+βC Equation 1

In equation 1, α and β are scaling constants and C is the result matrix C 116. Matrix A 130 is assumed to be of shape [M, K], matrix B 132 of shape [K, N] and hence matrix C 116 is of shape [M, N]. The rows of matrix A 130 are “M” dimensions, columns of matrix B 132 are “N” dimensions and a common dimension to matrix A 130 and matrix B 132 is a “K” dimension. The computations involved in GEMM are dense, therefore the accelerator 118 (e.g., a single instruction, multiple data (SIMD) or systolic array) may provide high efficiency.

In this example, the accelerator 118 has a memory 120 (e.g., a local SRAM), whose size is limited in comparison to the actual size of the matrix A 130, matrix B 132 and matrix C 116. Therefore, smaller blocks of the matrix A 130 and the matrix B 132 and are fetched into the memory 120 while computed results are stored back to a data storage (not illustrated). This process is referred to as blocking/tiling. Doing so may reduce the latency of compute and reduce bandwidth for GEMM operations.

Matrix A 130 includes first data and the matrix B 132 includes second data. In order execute the matrix multiplication operations, examples may block matrix A and matrix B and sequentially execute matrix multiplication operations on blocks of matrix A 130 and matrix B 132 to generate an output, which is matrix C 116.

That is, examples identify when large matrices are provided that exceed the capacity of the memory 120, and break the large matrices down into smaller blocks hierarchically for processing. The hierarchical breaking down of the large matrices into smaller blocks may be referred to as “blocking.”

As noted above, the first level of such blocking is referred to as a hypertile (referred to as HT below). Each HT represents a block of matrices A, B and C 130, 132, 116 that is able to reside in memory 120. In this example, Matrix A comprises four HTs A1 104, HT A2 106, HT A3 108 and HT A4 110. Matrix B 132 comprises HT B1 112 and HT B2 114. Matrix C 116 comprises HT C1 116a and HT C2 116b. One HT from each of matrix A 130, matrix B 132 and matrix C 116 (3 HTs total) consume an amount of memory that is less than or equal to a memory threshold of memory 120. For example, the memory threshold may be a remaining part of the memory 120 that is not is reserved for prefetched data.

That is, some examples may allocate a first amount of the memory 120 for data that is currently being processed for a first multiplication operation (current matrix multiplication operation associated with first HTs), and a second amount of the memory 120 for pre-fetched data for a second multiplication operation (e.g., future matrix multiplication operation associated with second HTs). Respective HTs of Matrix A 130 and Matrix B 132 may be stored in the memory 120 and a first matrix multiplication operation may be executed based on the respective HTs. The output of the first matrix multiplication operation maybe stored as part of matrix C 116 as a HT.

Sizing of the HTs A1 104, HT A2 106, HT A3 108, HT A4 110, HT B1 112, HT B2 114, HT C1 116a and HT C2 116b determines the bandwidth requirement of the accelerator 118 (e.g., a GEMM engine). That is, a larger sized HT implies larger data reuse and hence reduced bandwidth to transfer data back and forth between the memory 120 and a data storage that stores matrix A 130, matrix B 132 and matrix C 116 after matrix C 116 is generated.

The HTs A1 104, HT A2 106, HT A3 108, HT A4 110, HT B1 112 and HT B2 114 are further divided into groups (may also be referred to as stripes). The groups facilitate compute latency and efficiency. For example, each group includes data for one matrix multiplication operation of a plurality of matrix multiplication operations. The plurality of matrix multiplication operations represents a GEMM operation of multiplying matrix A 130 with matrix B 132.

For example, a first matrix multiplication operation may need first data from matrix A 130 and second data from matrix B 132 as input data. The HT A1 104 includes first group 104a-N group 104c. The first group 104a may include all of the first data from matrix A 130 that is needed for the first matrix multiplication operation. The first data is in the form of sub-tiles 104b. Furthermore, all of the data in sub-tiles 104b may be input data for the first matrix multiplication operation. Similarly, the HT B1 112 may include all of the second data which is represented as sub-tiles 112b of the first group 112a.

Similarly, the N group 104c may include all data from matrix A 130 that is needed to execute a second matrix multiplication operation, and N group 112c may include all data from the matrix B 132 that is needed for the second matrix multiplication operation. Thus, each group of matrix A 130 and matrix B 132 may each include all data from a respective matrix of the matrix A 130 and matrix B 132 that is needed to execute a matrix multiplication operation.

Each of the sub-tiles, such as sub-tiles 104b, 104d, 112b, 112d, are in an expected data size of the accelerator 118. That is, some examples identify an expected data input size of the accelerator 118. Examples then divide the data of matrix A 130 and matrix B 132 into a plurality of sub-tiles, where sizes of the plurality of sub-tiles are the expected data input size (e.g., 64×64) of the accelerator 118. Each group of matrix A 130 and matrix B 132 includes at least two of the plurality of sub-tiles.

In this example, the accelerator 118 receives the HT A1 104 and HT B1 112 and stores the HT A1 104 and HT B1 112 into memory 120. The HT A1 104 and HT B1 112 include data for several matrix multiplication operations. For example, each of the first group 104a to N group 104c may correspond to a different matrix multiplication operation of a plurality of matrix multiplication operations, and each of the first group 112a to N group 112c may correspond to a different matrix multiplication operation of the plurality of matrix multiplication operations. Retrieving data necessary for several matrix multiplication operation enhances compute efficiency and reduces latency since the accelerator 118 will not have to wait for data (e.g., stall) to execute one of the matrix multiplication operations. The first group 104a of the HT A1 104 and the first group 112a of the HT B1 112 include all data needed to execute a first matrix multiplication operation. Thus, sub-tiles 104b of the first group 104a and sub-tiles 112b of the first group 112a may be sequentially provided to the processing elements 122 to execute the first matrix multiplication operation.

For example, the processing elements 122 may form a systolic array that expects data of a certain size (e.g., 64×64). The sub-tiles 104b and sub-tiles 112b may be of the expected data size. For example, the sub-tiles A may be of the expected size of the systolic array, the sub-tiles B may be of the expected size and so on. That is, one sub-tile of sub-tiles A and one sub-tile of sub-tiles B are expected to be size of the systolic array. The PEs 122 may execute a matrix multiplication operation sequentially on each of the pairs of sub-tiles A, B, C, D, of the sub-tiles 104b, 112b, store partial outputs of the matrix multiplication operation and combine the partial outputs together to generate a final output. The final output may be stored as part of the matrix C 116.

For example, the sub-tiles 104b, 112b is the lowest hierarchy of blocking. The sub-tiles 104b, 112b (and all sub-tiles) ensure compute efficiency in a systolic array as data transfer happens with a minimum unit of the sub-tile 104b, 112b. One sub-tile of each of matrix A 130 and matrix B 132 are required for the accelerator 118 (e.g., a systolic array) to output one sub-tile of matrix C 116. Arranging data into the form of sub-tiles, such as sub-tiles 104b, 112b, ensures that once started, the processing elements do not starve/stall for data.

After the first groups 104a, 112a are determined to be no longer needed and may be evicted, a next group from a different HT, such as sub-tiles 106b of first group 106a of of the HT A2 106 and sub-tiles 114b of first group of 114a of the HT B2 114 may be transferred to the memory 120. For example, the groups further facilitate prefetching for a next HT. Furthermore, interleaving groups loaded from matrix A 130 and matrix B 132 keeps efficiency high even in bandwidth constrained systems.

The above described operation may repeat over each of the HT A1 104, HT A2 106, HT A3 108, HT A4 110, HT B1 112 and HT B2 114 to generate HT C1 116a and HT C2 116b of matrix C 116. That is, a plurality of matrix operations may be executed based on matrix A 130 and matrix B 132 to generate matrix C 116.

In some examples, a compiler 124 determines parameters relating to the above process. For example, the compiler 124 may be a GEMM compiler (GEMMC) that transforms the matrix multiplication operation into a set of instructions defined for the accelerator 118 (GEMM ISA). Some examples include data loading into the memory 120 from higher level memory (e.g., dynamic random access memory (DRAM)), with results/output being stored back to the higher-level memory and GEMM compute is implemented by these instructions.

The compiler 124 may determine the dimensions of the HT A1 104, HT A2 106, HT A3 108, HT A4 110, HT B1 112, HT B2 114, HT C1 116a and HT C2 116b as well as how the memory 120 is allocated. The compiler 124 may also determine locations in the memory 120 (e.g., SRAM slots) where groups of the HT A1 104, HT A2 106, HT A3 108, HT A4 110, HT B1 112 and HT B2 114, HT C1 116a and HT C2 116b reside. The compiler 124 may also generate LOAD, COMPUTE and STORE commands for matrix A 130 and matrix B 132.

There are three variables which may be optimized such that memory 120 has full occupancy while also providing bandwidth, reduced latency and enhanced compute efficiency. That is, HT_T_K (a number of sub-tiles in each group) may be fixed to as small as possible to enhance bandwidth. Setting a value of HT_T_K to be too small would make compute difficult as the systolic array needs to swap partials every tile from memory 120. Thus, an actual value of the size may be decided on silicon with a tradeoff for bandwidth, power and performance. In some examples, the compiler 124 determines the actual value of HT_T_K based on bandwidth, power and performance.

With HT_T_K fixed, HT_T_M, that is a number of groups of matrix A 130, and HT_T_N, that is a number of groups of matrix B 132, are selected in a way that makes the resulting HT adopt a square shape (or at least as close as possible) to handle any matrices. Thus, HT_T_M may be set to be as close as possible to HT_T_N.

A number of tiles that may reside in the memory 120 is given by the following Equation 2:

NUM_SUB_TILES_POSSIBLE=MEMORY_SIZE_IN_BYTES/SUB_TILE_SIZE_IN_BYTES Equation 2

In Equation 2, the NUM_SUB_TILES_POSSIBLE is the number of possible sub-tiles, MEMORY_SIZE_IN_BYTES is the amount of memory 120 and the SUB_TILE_SIZE_IN_BYTES is the size of each the sub-tile. The following equation 3 may derived from Equation 2:

HT_T_M*HT_T_K+HT_T_K*HT_T_N+HT_T_M*HT_T_N=NUM_SUB_TILES_POSSIBLE Equation 3

With HT_T_K as constant and HT_T_M==HT_T_N, above equation 3 becomes a quadratic equation which the compiler 124 solves to generate values for HT_T_M, HT_T_K and HT_T_N. In the above Equation 3, HT_T_M corresponds to the M dimension of matrix A 130, HT_T_K corresponds to the K dimension of matrix A 130, HT_T_N corresponds to the N dimension of Matrix B 132 and NUM_SUB_TILES_POSSIBLE is the number of possible sub-tiles.

Another brute-force approach is to scan through all possible combinations of HT_T_M and HT_T_N which satisfies equation 3 and find the best values which will utilize maximum amount of memory 120 and is closer to each other.

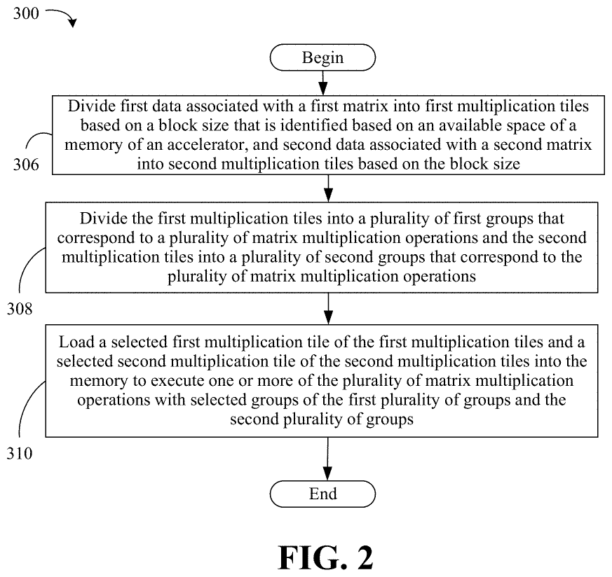

FIG. 2 shows a method 300 of executing GEMM operations with according to embodiments herein. The method 300 may generally be implemented with the embodiments described herein, for example, the matrix multiplication architecture 100 (FIG. 1) already discussed. More particularly, the method 300 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), general purpose microprocessor or combinational logic circuits, and sequential logic circuits or any combination thereof. The configurable or fixed-functionality logic can be implemented with complementary metal oxide semiconductor (CMOS) logic circuits, transistor-transistor logic (TTL) logic circuits, or other circuits.

For example, computer program code to carry out operations shown in the method 300 may be written in any combination of one or more programming languages, including an object-oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 306 divides first data associated with a first matrix into first multiplication tiles based on a block size that is identified based on an available space of a memory of an accelerator, and second data associated with a second matrix into second multiplication tiles based on the block size. Illustrated processing block 308 divides the first multiplication tiles into a plurality of first groups that correspond to a plurality of matrix multiplication operations and the second multiplication tiles into a plurality of second groups that correspond to the plurality of matrix multiplication operations. Illustrated processing block 310 loads a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

In some examples, the method 300 further includes identifying an expected data input size of the accelerator, identifying a first plurality of sub-tiles, wherein sizes of the first plurality of sub-tiles are the expected data input size, wherein the plurality of first groups includes the first plurality of sub-tiles, and identifying a second plurality of sub-tiles, wherein sizes of the second plurality of sub-tiles are the expected data input size, wherein the plurality of second groups includes the second plurality of sub-tiles.

In some examples of method 300, each of the plurality of first groups includes data for one matrix multiplication operation of the plurality of matrix multiplication operations, each of the plurality of second groups includes data for one matrix multiplication operation of the plurality of matrix multiplication operations, and the selected first multiplication tile includes a first matrix multiplication group of the plurality of first groups, and the selected second multiplication tile includes a second matrix multiplication group of the plurality of second groups, the first matrix multiplication group and the second matrix multiplication group including only input data to execute a first matrix multiplication operation of the plurality of matrix multiplication operations. In such examples, the method 300 further includes allocating a second amount of the memory to pre-fetch data, storing a first pre-fetch group of the plurality of first groups into the memory based on the second amount and while the accelerator executes a first matrix multiplication operation of the plurality of matrix multiplication operations, where the first pre-fetch group is associated with a second matrix multiplication operation of the plurality of matrix multiplication operations, and storing a second pre-fetch group of the plurality of second groups into the memory based on the second amount and while the accelerator executes the first matrix multiplication operation, wherein the second pre-fetch group is associated with the second matrix multiplication operation.

In some examples, the method 300 includes interleaving loads of data from the selected first multiplication tile and the selected second multiplication tile, and executing a compiler that determines a size of the selected first multiplication tile, a size of the selected second multiplication tile, a size of the first groups and a size of the second groups. In some examples, the memory is a unified memory that stores the selected first multiplication tile, the selected second multiplication tile and an output of the plurality of matrix multiplication operations, and the accelerator is a systolic array.

The method 300 may enhance several features of GEMM operations. Indeed, the method 300 may enhance bandwidth, latency and compute efficiency for GEMM operations and machine learning technological areas.

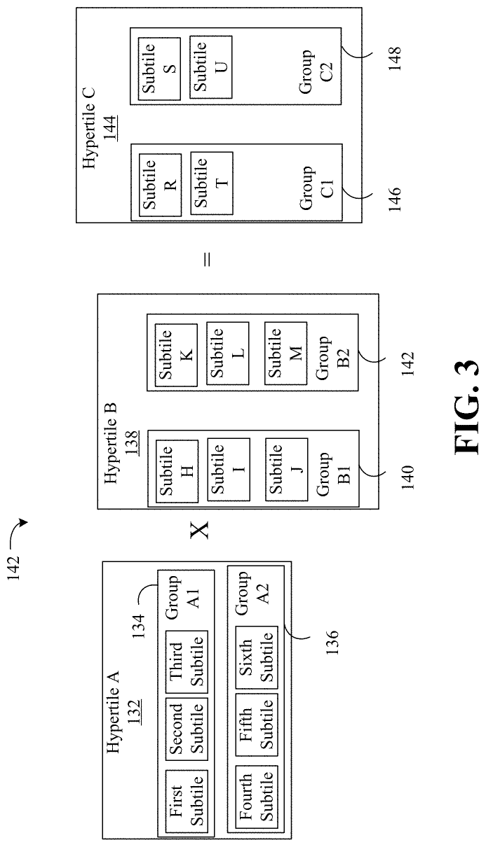

FIG. 3 illustrates an example of executing a matrix multiplication operation 142 with HTs. The matrix multiplication operation 142 may generally be implemented with the embodiments described herein, for example, the matrix multiplication architecture 100 (FIG. 1) and/or the method 300 (FIG. 2) already discussed. In this example, a HT A 132 is to be multiplied with HT B 138. The HT A 132 represents a small block of a complete matrix A, the HT B 138 represents a small block of complete matrix B and HT C 144 represents a small block of complete output matrix C. The HT A 132, the HT B 138 and HT C 144 are sized to be able to simultaneously reside in an accelerator memory. For example, the HT A 132, HT B 138 and HT C 144 consume “X” % of the memory. A remaining part of the memory (e.g., 100−X)% is reserved for prefetched data for a next HT and data for a next matrix multiplication operation. Sizing of HT A 132, HT B 138 and HT C 144 determine the bandwidth requirement of the accelerator. A larger HT implies larger reuse and hence reduced bandwidth.

HT A 132, HT B 138 and HT C 144 are further broken down into groups, including group A1 134, group A2 136, group B1 140, group B2 142, group C1 146 and group C2 148. The group A1 134, group A2 136, group B1 140, group B2 142, group C1 146 and group C2 148 determine compute latency and efficiency. For example, the different groups correspond to different matrix multiplication operations and therefore are provided to an accelerator on a group-by-group basis to avoid waits, stalls and reloading of data.

That is, a first matrix multiplication operation may include executing matrix multiplication with group A1 134 with group B1 140, and in particular first sub-tile with sub-tile H to generate a first product, second sub-tile with sub-tile I to generate a second product, and third sub-tile with sub-tile J to generate a third product. The first matrix multiplication operation may then include summing the first, second and third products to generate sub-tile R (e.g., sub-tile R is the sum of the first product, second product and third product). A next operation may include executing matrix multiplication on group A1 134 and group B2 142 to generate sub-tile S. Thus, in order to streamline operations and reduce data fetching and memory evictions, the accelerator may operate on a group-by-group basis. For example, the accelerator may process the first-third and H-J sub-tiles on the group A1 134 and the group B1 140 sequentially and prior to processing any of the group A2 136 and group B2 142.

The group A1 134, group A2 136, group B1 140, group B2 142, group C1 146 and group C2 148 also facilitate prefetch for next HT. Interleaving of groups loaded from A and B matrices keeps efficiency high even in bandwidth constrained systems. Interleaving may alternate whether data is loaded from the HT A 132 and the HT B 138, and evictions from memory may also alternate between evicting data from the HT A 132 and evicting data from the HT B 138.

The first-sixth sub-tiles and the H-M sub-tiles is the lowest hierarchy of blocking. The sub-tiles ensure compute efficiency in the accelerator (e.g., a systolic array) as data transfer happens with a minimum unit of the first-sixth sub-tiles and the H-M. One of the first-sixth sub-tiles and one of the H-M are required for the accelerator to output and provide one sub-tile of resultant C. Sub-tiles ensure that once started, a systolic array does not starve/stall for data.

For a given blocking method, determining the size of blocks and manner/order in which the blocks are processed (walk) at each level of hierarchy largely determines performance factors. Block-size is configurable to address a variety of matrix and hardware configurations on silicon. Block-sizing dictates storage (e.g., DRAM) bandwidth/power trade-off with respect to power/efficiency of compute engine. A GEMM compiler (discussed above) that determines sizing of the block and order of block processing solves this problem. For least bandwidth requirement, best on-chip memory needs to be dynamically allocated between matrices A, B and C. Typically engines have a static distribution making the on-chip memory utilization in-efficient. Thus, examples may flexibly modify sizes of the HTs A 132, B 138, C 144, group sizes of group A1 134, group A2 136, group B1 140 and group B2 142, and sizes of first-sixth, H-M and R-U sub-tiles based on various metrics, including bandwidth, latency and expected input size of an accelerator.

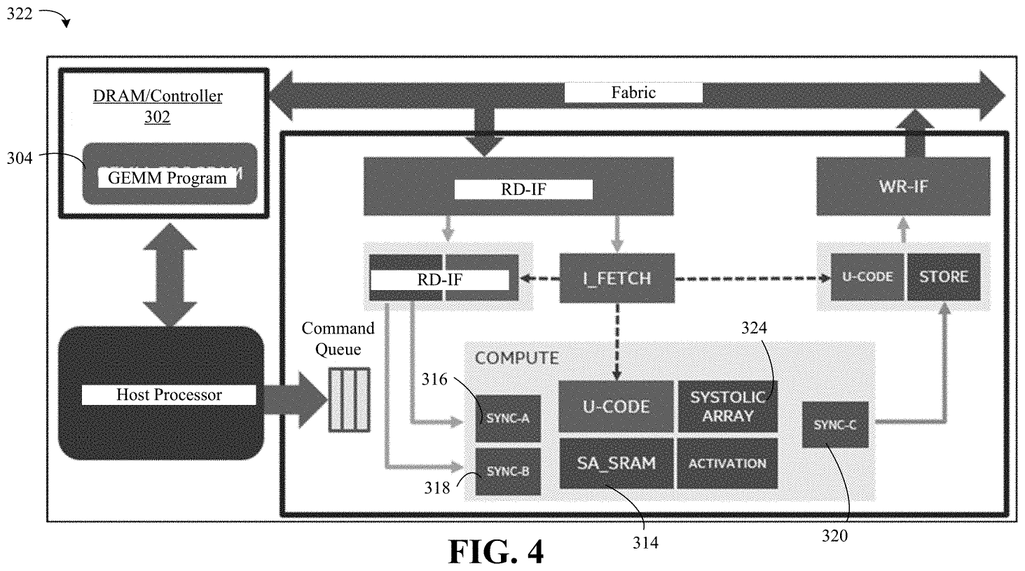

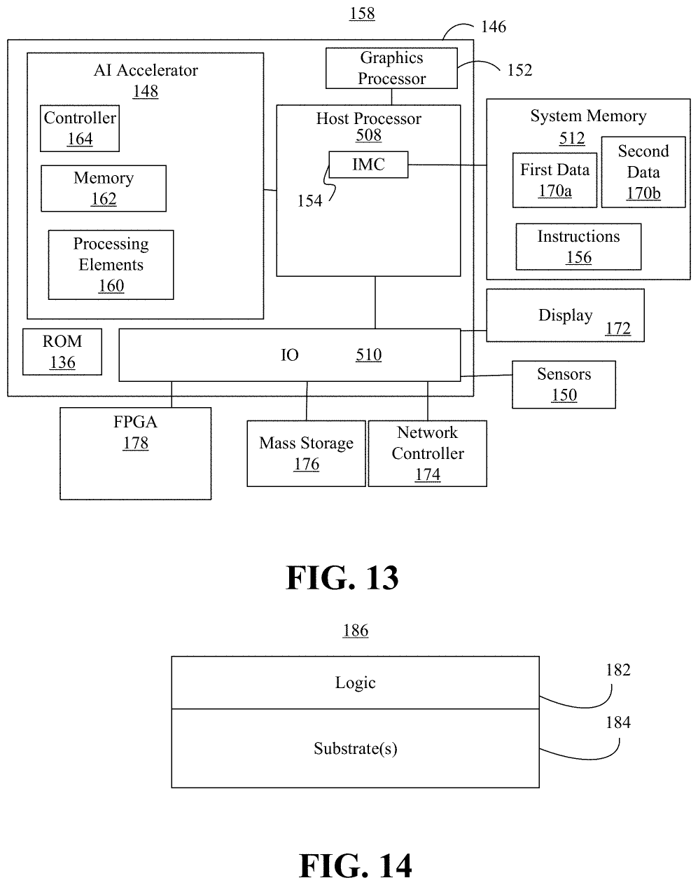

FIG. 4 shows a block diagram of a hardware architecture 322 for performing a GEMM operation. The hardware architecture 322 may generally be implemented with the embodiments described herein, for example, the matrix multiplication architecture 100 (FIG. 1), the method 300 (FIG. 2) and/or the matrix multiplication operation 142 (FIG. 3) already discussed. An Instruction set architecture (ISA)/program description is provided below. A Compiler creates a GEMM program 304 that is loaded into the DRAM/controller 302. The GEMM program 304 is constructed using ISA (discussed below). An exemplary implementation of the GEMM program 304 is shown in FIG. 13 (below).

I_FETCH is a command to fetch GEMM program 304 from the DRAM/controller 302. and LOAD, STORE and COMPUTE instructions of the GEMM program 304 are pushed into respective hardware modules.

During program execution, a LOAD instruction is for loading a group of matrix A or B from the DRAM/controller 302 to on-chip SA_SRAM 314. When applicable a LOAD also loads a tile of partials of an output matrix (e.g., C-matrix).

COMPUTE operates on a group of matrix A, a group of matrix B and produces a tile as a result. Systolic Array (SA) 324 includes a 2D array of Multiply Accumulate (MAC) units (e.g., processing elements). A TILE of data is equal to the Systolic Array dimensions. Thus, for a 64×64 SA, each tile of data is also equal to 64×64. STORE copies data from SA_SRAM 314 (accelerator memory) to DRAM/controller 302. Since the result of one COMP instruction is a TILE, the granularity of STORE is also one TILE

SYNC-AB 316, 318 bits are used between LOAD and COMPUTE for each SLOT of SA-SRAM 314. SLOT is memory space in SA-SRAM 314 that holds one group for the matrix A/matrix B. There is one SYNC bit associated with each SLOT of SA-SRAM. Bit set indicates a GROUP of data is available for compute. Once the GROUP is completely used up, the SYNC bit is cleared (based on A-DONE, B-DONE bits in COMP instruction).

SYNC-C 320 bits are used between COMPUTE and STORE for each TILE of data. Bit set indicates a TILE of data is available to be stored in the DRAM 302. Once STORE moves the data to DRAM 302, the bit is cleared

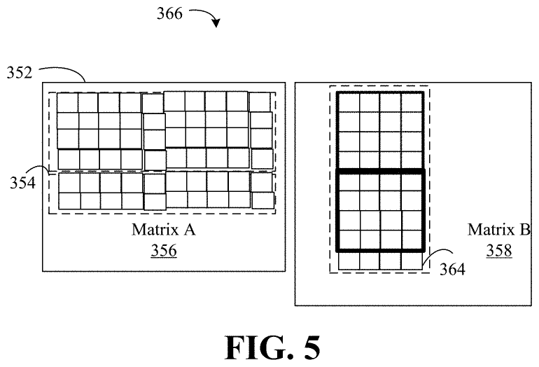

FIG. 5 illustrates boundary conditions, and in particular HTs 366 including data that do not fill a complete group. The boundary conditions may generally be implemented with the embodiments described herein, for example, the matrix multiplication architecture 100 (FIG. 1), the method 300 (FIG. 2), the matrix multiplication operation (FIG. 3) and/or hardware architecture 322 (FIG. 4), already discussed. Boundary conditions are cases where entire block (e.g., HT, group, sub-tile) is not available for fetching/compute and is only partially filled with data. For example, second group 354 of matrix A 356 is partially filled, and group 364 of matrix B 358 is only partially filled.

Boundary conditions based on the above may be specified as shown in Table I below to notify processing hardware (e.g., accelerators) that the block is not entirely filled.

TABLE I

| | |
|---|---|
| HT_T_M | 2 |
| HT_T_K | 3 |
| HT_T_K | 1 |
| Boundary_M | 2 |
| Boundary_K | 2 |
| Boundary_N | 0 |
| (BM, BK, BN) | (1, 1, 0) |
| Bound | 1 |

For the appropriate dimension (e.g., dimension M=rows of matrices A (illustrated) and C (not illustrated), N=columns of matrices B (illustrated) and C (not illustrated), K is matrix A columns and/or matrix B rows). Flags BM, BK, BN indicate a boundary condition is present in that dimension. BOUNDARY_M/K/N indicate the number of elements in that dimension for the boundary block. Identifying, handling and responding to boundary conditions eliminates fetching/computing/storing of unwanted data. For example, when a boundary condition is detected, the above flags may be analyzed to determine how much data to retrieve to avoid retrieving and operating on data outside the scope of matrix multiplication operations as described herein.

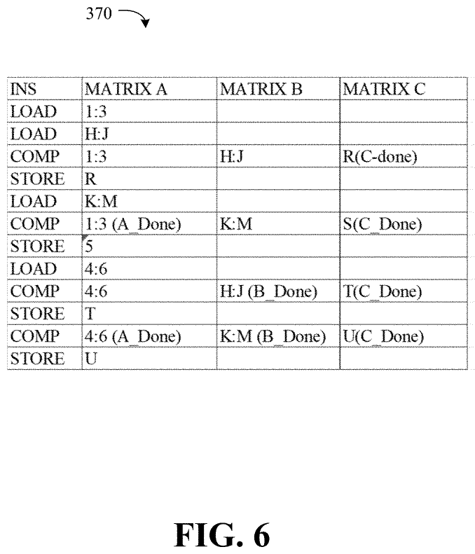

FIG. 6 illustrates a program 370 for processing matrices A, B and C as shown in FIG. 1. The program 370 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4) and/or boundary conditions (FIG. 5), already discussed. A_DONE, B_DONE are flags in COMP instruction (compute) that are set respectively when the groups for A and B are completely used up. The C_DONE flag in the COMP instruction is set when the C-TILE result is ready to be stored from local memory to DRAM (e.g., when there is no more partial accumulation left).

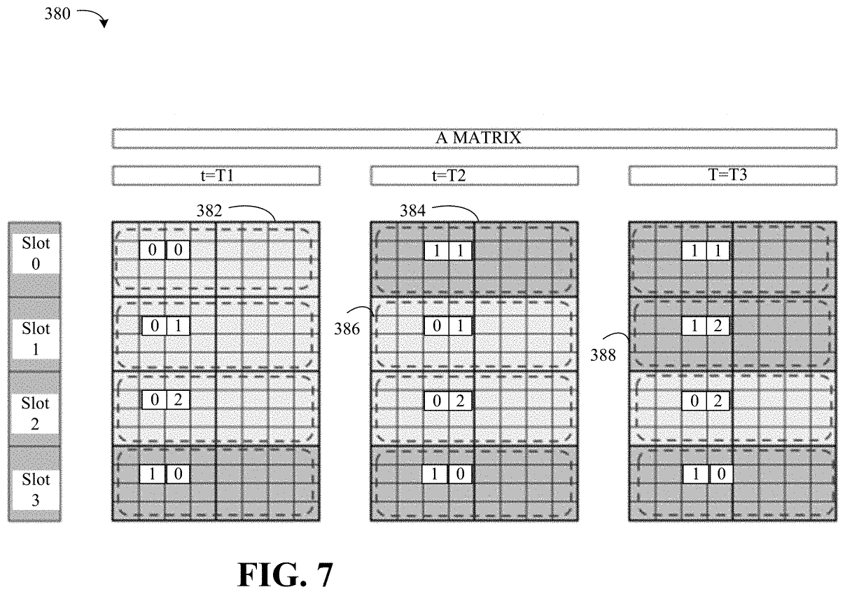

FIG. 7 illustrates memory slots 0-3 to load groups of data. The memory slots 0-3 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), and/or program 370 (FIG. 6) already discussed.

Groups are loaded into memory slots 0-3 (memory empty space corresponding to a group) of the memory 380 for consecutive HTs of one of the matrices (e.g., an A matrix). At time t=T1, memory SLOT 0, 1, 2 has groups of HT 0 and SLOT 3 has a first group 0 of HT 1 (e.g., a prefetch for a next HT which is HT 1). At time point t=T2, once group 382 (e.g., labeled as 0, 0) of HT0 is utilized and no longer needed, slot 0 is loaded with a second group 384 of HT 1. Next, slot 386 is to be evicted since the data for slot 386 (e.g., 0, 1) was used and is no longer needed. Thus, a third group 388 of HT1 is prefetched. FIG. 7 illustrates how slots are occupied in a circular buffer manner

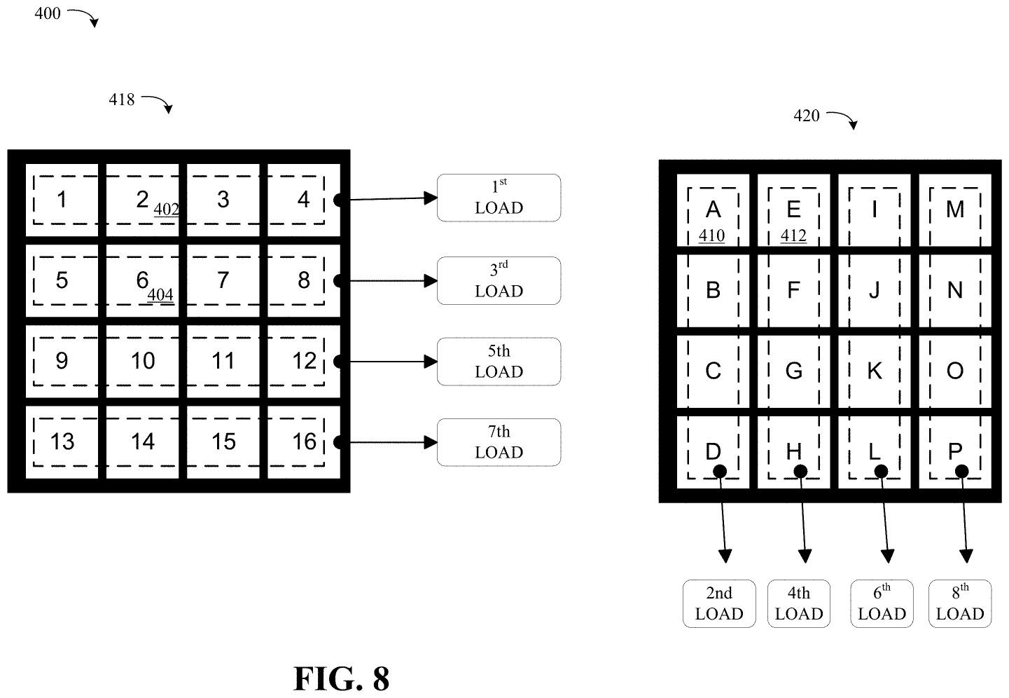

FIG. 8 illustrates an interleaved load process 400 of groups from HTs of matrices A and B. The interleaved load process 400 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6) and/or memory 380 (FIG. 7) already discussed. For example, hardware of implementations as described herein may be designed for interleaved execution, or concurrent execution of LOAD and COMPUTE instructions. In doing so, examples achieve high compute efficiency by interleaved loading of groups from matrices of A and B. This is explained below in which four groups are stored in memory slots 418 for matrix A, and 4 groups are stored in memory slots for matrix B. Matrix A and matrix B may be inputs into a matrix multiplication operation. A HT for matrix A and a HT for matrix B may be 4 groups and are stored in the memory slots 418, 420.

The Following table shows interleaved loading instructions for A and B. In the following table, hardware Config 1:SA Width:External Memory Width=4:1, indicates compute instruction executes 4 times faster than Load instruction. Hardware config 2:SA Width:External Memory Width=2:1 indicates that compute instruction executes 2 times faster than Load instruction. Thus, table II includes two different hardware configurations with different waits and values.

TABLE II

| | | | | | HW | | HW |
|---|---|---|---|---|---|---|---|
| | | | | HW | Config | HW | Config |
| | | | | Config. | 1 (Clock | Config | 2 (Clock |
| | | | | l Wait | Cycle | 2 (Wait | Cycle |
| Ins. | A | B | C | Cycles | Values) | Cycles) | Values) |
| Load | 1:4 | | | | | | |
| Load | A:D | | | | | | |
| COMP | 1:4 | A:D | Cl | 2 × SA | 2048 | 2 × SA | 1024 |
| | | | (C_DONE) | width × | | width × | |
| | | | | K × 4 | | K × 2 | |
| STORE | C1 | | | | | | |
| LOAD | 5:8 | | | | | | |
| COMP | 5:8 | A:D | C2 | SA | 768 | SA | 256 |
| | | | (C_DONE) | width × | | width × | |
| | | | | K × 3 | | K × 1 | |
| STORE | C2 | | | | | | |
| LOAD | E:H | | | | | | |
| COMP | 1:4 | E:H | C3 | SA | 768 | SA | 256 |
| | | | (C_DONE) | width × | | width × | |
| | | | | K × 3 | | K × 1 | |
| STORE | C3 | | | | | | |
| COMP | 5:8 | E:H | C4 | 0 | | 0 | |
| | | | (C_DONE) | | | | |
| STORE | C4 | | | | | | |
| LOAD | 9:12 | | | | | | |
| COMP | 9:12 | A:D | C5 | SA | 512 | 0 | |
| | | | (C_DONE) | width × | | | |
| | | | | K × 2 | | | |
| STORE | C5 | | | | | | |
| COMP | 9:12 | E:H | C6 | 0 | | 0 | |
| | | | (C_DONE) | | | | |

The first two lines of Table II load sub-tiles 1-4 (e.g., one group of matrix A) into slot 402, and sub-tiles A-D (e.g., one group of matrix B) into slot 410. The third line of Table II is a compute instruction to execute matrix multiplication on sub-tiles 1-4 and sub-tiles A-D. The loading of sub-tiles 1-4 and sub-tiles A-D causes a delay of 2×SA width (systolic array width)×K×4 for hardware configuration 1, and a delay of 2×SA width×K×2 for hardware configuration 2 prior to compute. The fourth line stores an output of the computation of the third line as C1 and the fifth line loads sub-tiles 5-8 of matrix A into slot 404. The sixth line then identifies a computation based on sub-tiles 5-8 and sub-tiles A-D. The wait time is decreased however since only load occurs, with a delay of SA width×K×3 for hardware configuration 1, and a delay of SA width×K×1 for hardware configuration 2 prior to compute. C2 (an output of the previous computation may then be stored).

Next, sub-tiles E-H are loaded into slot 412 for the next computation. Thus, the loading may be considered interleaved at least to the extent that loads of groups of sub-tiles alternate between matrix A and matrix B. Doing so substantially reduces load and wait times as opposed to situations where one group of matrix A is loaded, and then four groups of matrix B are sequentially loaded. Table II may include further instructions (not illustrated) to load groups of sub-tiles, compute values based on the groups of sub-tiles and store the values.

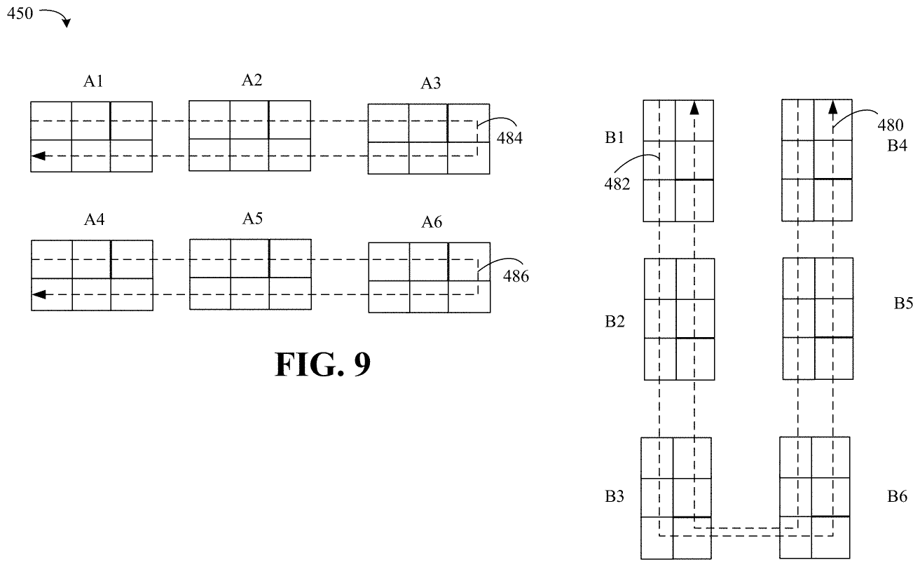

FIG. 9 illustrated a zig-zag load pattern 450 according to examples described herein. The zig-zag load pattern 450 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7) and/or interleaved load process 400 (FIG. 8) already discussed. The HTs A1-A6 of matrix A and B1-B6 of matrix B are loaded into a local memory of an accelerator and a matrix multiplication operation is computed as illustrated by the arrows 484, 486, 482, 480. That is, as shown in arrow 484, loads occur from HTs A1, A2, A3, A2, A1, A4, A5, A6, A5, A4 to increase reuse. Similarly, HTs B1, B2, B3, B6, B5, B4, B5, B6, B3, B2, B1. This results in maximum reuse of data and reduces the amount of data fetch from data storage (e.g., DRAM). The compute sequence is provided below:

TABLE III
Compute Sequence
Al × Bl
A2 × B2
A3 × B3
A3 × B6
A2 × B5
Al × B4
A4 × B4
A5 × B5
A6 × B6
A6 × B3
A5 × B2
A4 × Bl

Thus, some examples load HTs into the memory to increase reuse of data and reduce reloading of data. In the above table, HTs that are reused across computational cycles are in bold. For example, HT A3 is used twice in a row and therefore remains in the memory for two consecutive computational cycles while only being loaded once. That is, HT A3 is not evicted from the memory between the two consecutive computational cycles and need not be reloaded for the second computational cycle. In contrast, a linear loading and computational process would load HT A1 and HT B1, HT A2 and HT B2, HT A3 and HT B3, HT Al and HT B4 (HT A3 was evicted), HT A2 and HT B5, HT A3 and HT B6 (HT A3 is reloaded), HT A4 and HT B 1, until all values are calculated. Thus, a linear loading process loads all nearly all data at least twice, while the zig-zag process reduces the amount of data that must be reloaded such that some data is only loaded once. That is, the linear process lacks any reuse of data across consecutive computational cycles and result in fetching 24 HT in total (compared to 21 HT in the zigzag compute scenario).

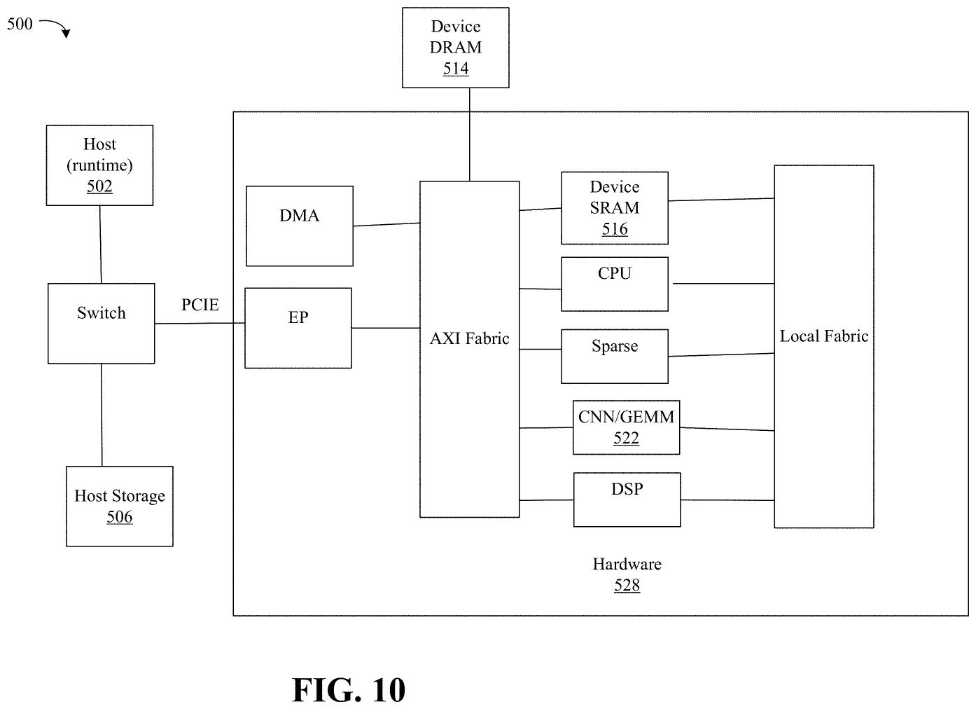

FIG. 10 illustrates a system view of a GEMM architecture 500. Hardware 528 may be an accelerator. The GEMM architecture 500 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8) and/or zig-zag load pattern 450 (FIG. 9) already discussed. The host 502 and the host storage 506 generate data to be processed. For example, the host 502 may generate data (e.g., matrices A and B in this case) that is to be transferred to the device DRAM 514 (e.g., a device storage) for the hardware 528 to process. An objective of the command queue is for the hardware 528 to have a sequence of commands to execute at any time and in the process manage data transfer between host 502 and device DRAM 514 when compute is BUSY. Doing so enables very high efficiency compute. As illustrated, the hardware includes a device SRAM 516 in which HTs are stored for compute operations by the CNN/GEMM 522.

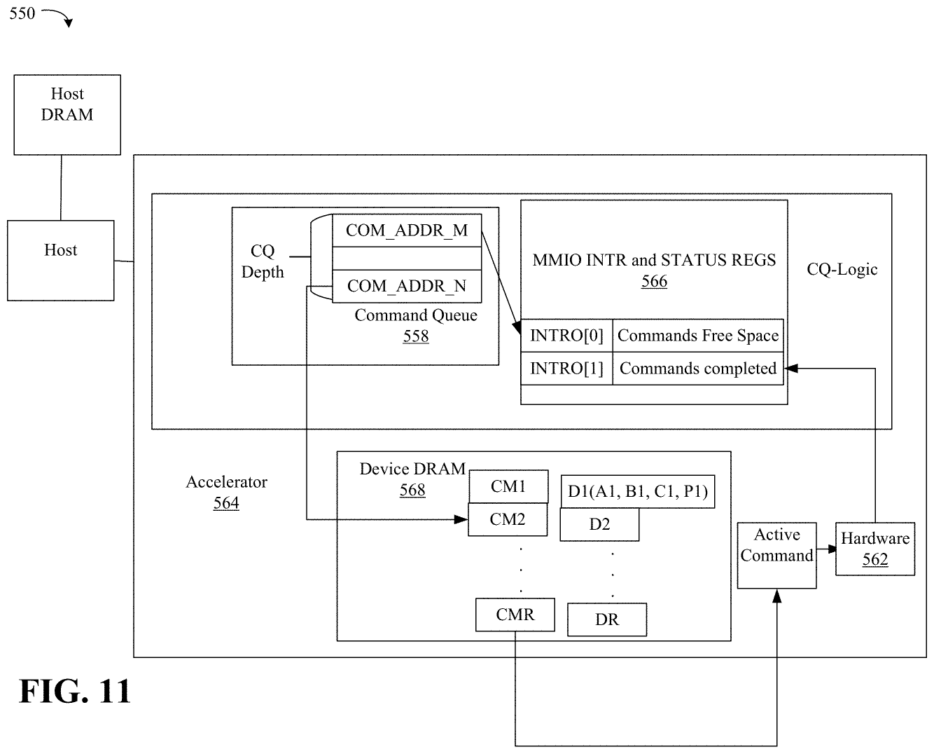

FIG. 11 illustrates a GEMM computing architecture 550 including a command queue 558 for an accelerator 564. The GEMM computing architecture 550 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8), zig-zag load pattern 450 (FIG. 9) and/or general matrix multiply operation architecture (FIG. 10) already discussed. A command is a set of registers required for the hardware 562 to operate upon one work unit. FIG. 11 illustrates a command queue 558 which is exposed as a set of Memory-mapped I/O (MMIO) INTR and status registers 566. The command queue 558 has a CQ_DEPTH of number of entries. At any point the number of entries available in CQ (free space) is made available via commands free space status registers of the MMIO INTR and status registers 566.

Software may check for the value of the commands free space registers and issues a command based on the same such as PREP_CMD, EXE_CMD and/or as many commands as available space in device DRAM 568.

A preparing command (PREP_CMD) includes copying input matrices A and B, creating output space for matrix C (a product of matrices and B) and copying all configuration and/or program information required for a matrix multiplication operation to execute, into the device DRAM 568. The D1, D2 . . . DR entries in device DRAM 568 represents all input matrices, configuration and/or programs, and allocated output storage space. CM1, . . . CMR are the corresponding commands.

For example, an execute command (EXE_CMD) includes programming the address of CM1, . . . CMR into the command queue 558. Software writes a lesser of the COMMANDS_FREE_SPACE or DRAM space available worth of commands into the command queue 558. Hardware pops the command queue 558, fetches the command from device DRAM 568 and makes the fetched command the active command. Upon completion of the active command, for example the last byte of result data is stored into device DRAM 568, INTR is set and COMMANDS_COMPLETED is incremented. A response command (RESP_CMD) copies computed results from DEVICE DRAM to HOST DRAM.

Even though the accelerator 564 (e.g., a systolic array) is highly compute efficient, this high efficiency is realized only if the data required for later computes and results of earlier computes are being transferred while the current compute is in progress. Data transfers should be hidden behind compute and dependencies should be managed in a configurable manner in order to support a variety of matrix dimensions. GEMM Instruction Set Architecture (discussed below) solves this problem.

Accelerators with a dedicated device DRAM also require that data transfers between the HOST DRAM and device DRAM are also hidden behind compute time. Command queue 558 solve this problem by masking data transfers behind compute time.

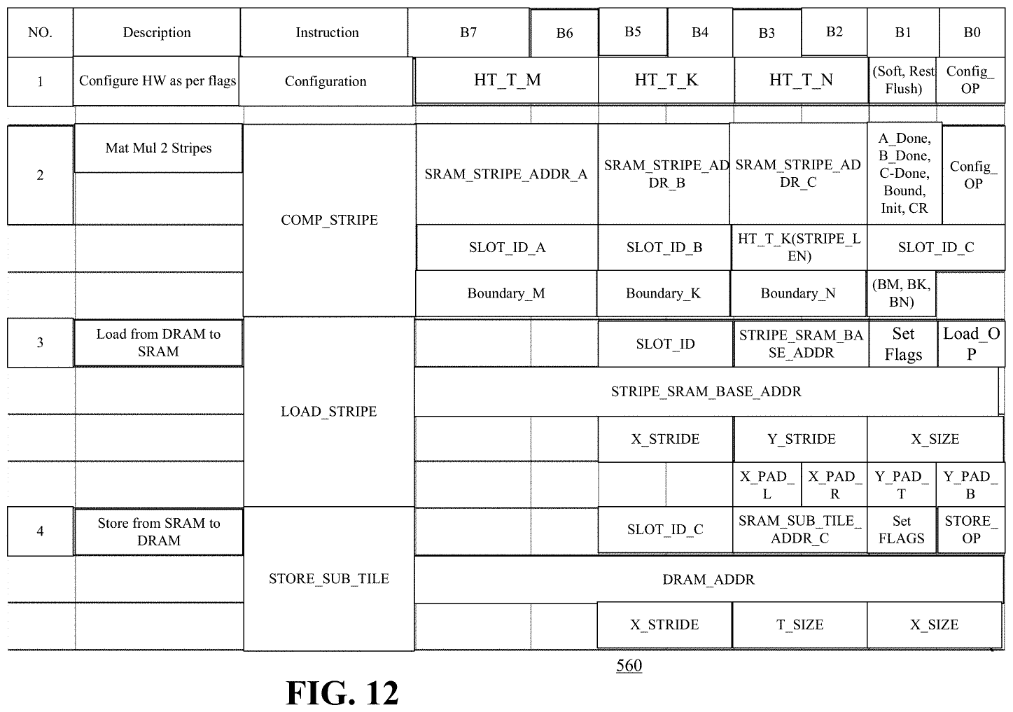

FIG. 12 illustrates an instruction set architecture (ISA) 560 for a GEMM accelerator. The ISA 560 may generally be implemented with the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8), zig-zag load pattern 450 (FIG. 9), GEMM architecture 500 (FIG. 10) and/or GEMM computing architecture 550 (FIG. 11) already discussed.

The ISA has 4 instructions discussed below. The LOAD command Loads a STRIPE (e.g., 2D array or group) from a given DRAM address (STRIPE_DRAM_ADDRESS) to an SA_SRAM slot (e.g., memory) with index SLOT_ID. The size of 2D array is determined by X_STRIDE, Y_SIZE and X_SIZE. All LOAD instructions do not carry the size info, and it exists only if FLAG UPDT_SZ is true. CH_ID determines if the data being loaded is for matrix A, B or C (partials).

The STORE command stores a SUB-TILE of data from SLOT_ID_C in SA_SRAM to DRAM_ADDR in DRAM. The COMPUTE command multiplies a group (e.g., a stripe) of data from SLOT_ID_A and to another from SLOT_ID_B and writes the result to SLOT_ID_C. All the SLOT_IDs are determined by the compiler. A DONE, B_DONE flags indicate to LOAD a stripe(s) in SLOT_ID_A and B that can be retired and filled with new data. C_DONE flag indicates to STORE that a sub-tile is computed completely and can be pushed to a DRAM. A group (e.g., stripe) of matrix A multiplied with a group (e.g., stripe) of matrix B gives a sub-tile as output. Matrix dimensions need not be integral to multiples of sub-tile dimensions. In case it the matrix dimensions are not, BOUND flag is set and also the dimension in which the boundary condition occurs is indicated by flag BM, BK, BN flags. BOUNDARY_M/K/N represents number of elements in that dimension as discussed in HTs 366 (FIG. 5).

Turning now to FIG. 13, a GEMM computing system 158 is shown. The GEMM computing system 158 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot, manufacturing robot, autonomous vehicle, industrial robot, etc.), edge device (e.g., mobile phone, desktop, etc.) etc., or any combination thereof. In the illustrated example, the computing system 158 includes a host processor 138 (e.g., CPU) having an integrated memory controller (IMC) 154 that is coupled to a system memory 512.

The illustrated computing system 158 also includes an input output (IO) module 510 implemented together with the host processor 138, the graphics processor 152 (e.g., GPU), ROM 136, and AI accelerator 148 on a semiconductor die 146 as a system on chip (SoC). The illustrated IO module 510 communicates with, for example, a display 172 (e.g., touch screen, liquid crystal display/LCD, light emitting diode/LED display), a network controller 174 (e.g., wired and/or wireless), FPGA 178 and mass storage 176 (e.g., hard disk drive/HDD, optical disk, solid state drive/SSD, flash memory). The IO module 510 also communicates with sensors 150 (e.g., video sensors, audio sensors, proximity sensors, heat sensors, etc.).

The SoC 146 may further include processors (not shown) and/or the AI accelerator 148 dedicated to artificial intelligence (AI) and/or neural network (NN) processing. For example, the system SoC 146 may include vision processing units (VPUs,) and/or other AI/NN-specific processors such as the AI accelerator 148, etc. In some embodiments, any aspect of the embodiments described herein may be implemented in the processors, such as the graphics processor 152 and/or the host processor 508, and in the accelerators dedicated to AI and/or NN processing such as AI accelerator 148 or other devices such as the FPGA 178.

The graphics processor 152, AI accelerator 148 and/or the host processor 508 may execute instructions 156 retrieved from the system memory 512 (e.g., a dynamic random-access memory) and/or the mass storage 176 to implement aspects as described herein. For example, a controller 164 of the AI accelerator 148 may execute a GEMM process based on first data 170a and the second data 170b. For example, the first data 170a may represent a first matrix and the second data 170b may represent a second matrix. The AI accelerator 148 may include a controller 164 that divides the first data associated with the first matrix into first multiplication tiles based on a block size that is identified based on an available space of a memory 162 of the AI accelerator 148, and the second data 170b associated with the second matrix into second multiplication tiles based on the block size. The controller 164 divides the first multiplication tiles into a plurality of first groups that correspond to a plurality of matrix multiplication operations and the second multiplication tiles into a plurality of second groups that correspond to the plurality of matrix multiplication operations. The controller 164 loads a selected first multiplication tile of the first multiplication tiles and a selected second multiplication tile of the second multiplication tiles into the memory 162 to execute one or more of the plurality of matrix multiplication operations with selected groups of the first plurality of groups and the second plurality of groups. For example, the processing elements 160 may execute the one or more of the plurality of matrix multiplication operations.

In some examples, when the instructions 156 are executed, the computing system 158 may implement one or more aspects of the embodiments described herein. For example, the computing system 158 may implement one or more aspects of the embodiments described herein, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8), zig-zag load pattern 450 (FIG. 9), GEMM architecture 500 (FIG. 10), GEMM computing architecture 550 (FIG. 11) and/or ISA 560 (FIG. 12) already discussed. The illustrated computing system 158 is therefore considered to be accuracy and efficiency-enhanced at least to the extent that the computing system 158 may train over a significant amount of unlabeled data.

FIG. 14 shows a semiconductor apparatus 186 (e.g., chip, die, package). The illustrated apparatus 186 includes one or more substrates 184 (e.g., silicon, sapphire, gallium arsenide) and logic 182 (e.g., transistor array and other integrated circuit/IC components) coupled to the substrate(s) 184. In an embodiment, the apparatus 186 is operated in an application development stage and the logic 182 performs one or more aspects of the embodiments described herein. For example, the apparatus 186 may generally implement the embodiments described herein, for example the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8), zig-zag load pattern 450 (FIG. 9), GEMM architecture 500 (FIG. 10), GEMM computing architecture 550 (FIG. 11) and/or ISA 560 (FIG. 12) already discussed. The logic 182 may be implemented at least partly in configurable logic or fixed-functionality hardware logic. In one example, the logic 182 includes transistor channel regions that are positioned (e.g., embedded) within the substrate(s) 184. Thus, the interface between the logic 182 and the substrate(s) 184 may not be an abrupt junction. The logic 182 may also be considered to include an epitaxial layer that is grown on an initial wafer of the substrate(s) 184.

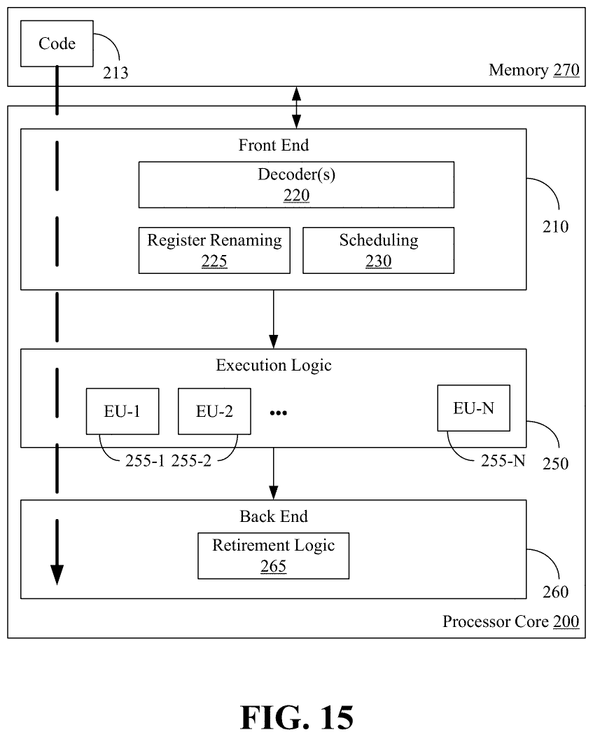

FIG. 15 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 15, a processing element may alternatively include more than one of the processor core 200 illustrated in FIG. 15. The processor core 200 may be a single-threaded core or, for at least one embodiment, the processor core 200 may be multithreaded in that it may include more than one hardware thread context (or “logical processor”) per core.

FIG. 15 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement one or more aspects of the embodiments such as, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8), zig-zag load pattern 450 (FIG. 9), GEMM architecture 500 (FIG. 10), GEMM computing architecture 550 (FIG. 11) and/or ISA 560 (FIG. 12) already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end portion 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include several execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 15, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

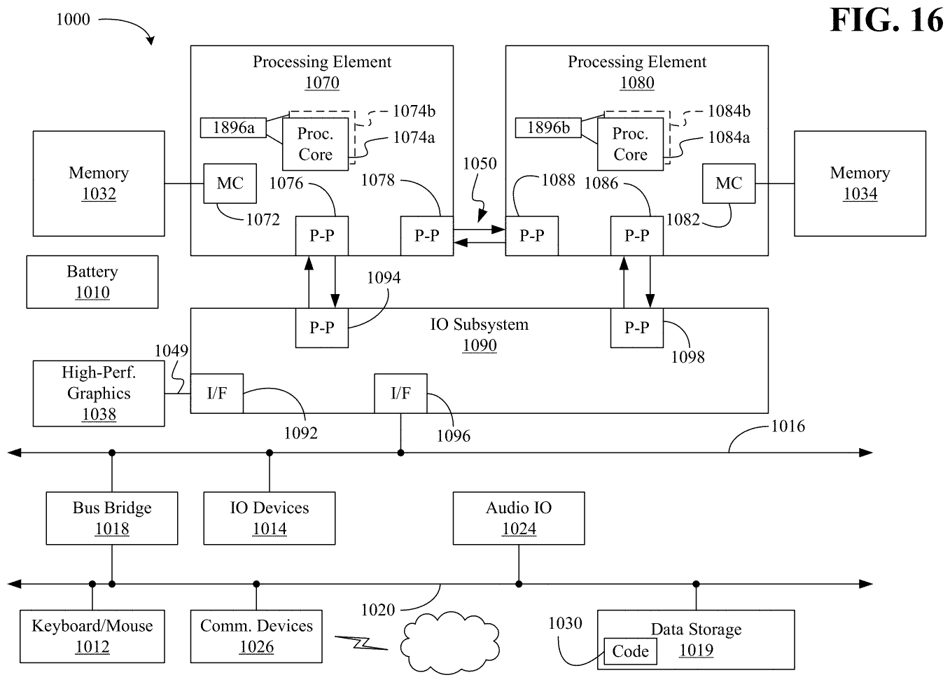

Referring now to FIG. 16, shown is a block diagram of a computing system 1000 embodiment in accordance with an embodiment. Shown in FIG. 16 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood any or all the interconnects illustrated in FIG. 16 may be implemented as a multi-drop bus rather than point-to-point interconnect.

As shown in FIG. 16, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner like that discussed above in connection with FIG. 15.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments is not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 15, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 15, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments is not so limited.

As shown in FIG. 15, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the one or more aspects of such as, for example, the matrix multiplication architecture 100 (FIG. 1), the method 300 (FIG. 2), the matrix multiplication operation (FIG. 3), hardware architecture 322 (FIG. 4), boundary conditions (FIG. 5), program 370 (FIG. 6), memory 380 (FIG. 7), interleaved load process 400 (FIG. 8), zig-zag load pattern 450 (FIG. 9), general matrix multiply operation architecture 500 (FIG. 10), GEMM computing architecture 550 (FIG. 11) and/or ISA 560 (FIG. 12) already discussed. Further, an audio I/O 1024 may be coupled to second bus 1020 and a battery 1010 may supply power to the computing system 1000.

Note that other embodiments are contemplated. For example, instead of the point-to-point architecture of FIG. 16, a system may implement a multi-drop bus or another such communication topology. Also, the elements of FIG. 16 may alternatively be partitioned using more or fewer integrated chips than shown in FIG. 16.

Additional Notes and Examples:

Example 1 includes a computing system comprising a data storage to store first data for a first matrix and second data for a second matrix, an accelerator to perform a plurality of matrix multiplication operations and that includes a memory, and a controller implemented in one or more of configurable logic or fixed-functionality logic, wherein the controller is to divide the first data into first multiplication tiles based on a block size that is identified based on an available space of the memory, and the second data into second multiplication tiles based on the block size, divide the first multiplication tiles into a plurality of first groups that correspond to the plurality of matrix multiplication operations and the second multiplication tiles into a plurality of second groups that correspond to the plurality of matrix multiplication operations, and load a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

Example 2 includes the computing system of Example 1, wherein the controller is further to identify an expected data input size of the accelerator, identify a first plurality of sub-tiles, wherein sizes of the first plurality of sub-tiles are the expected data input size, wherein the plurality of first groups includes the first plurality of sub-tiles, and identify a second plurality of sub-tiles, wherein sizes of the second plurality of sub-tiles are the expected data input size, wherein the plurality of second groups includes the second plurality of sub-tiles.

Example 3 includes the computing system of Example 1, wherein each of the plurality of first groups includes data for one matrix multiplication operation of the plurality of matrix multiplication operations, each of the plurality of second groups includes data for one matrix multiplication operation of the plurality of matrix multiplication operations, and the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

Example 4 includes the computing system of Example 3, wherein the controller is further to allocate a second amount of the memory to pre-fetch data, store a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations, and store a second pre-fetch group of the plurality of second groups into the memory based on the second amount and while the accelerator executes the first matrix multiplication operation, wherein the second pre-fetch group is associated with the second matrix multiplication operation.

Example 5 includes the computing system of any one of Examples 1 to 4, wherein the controller is further to interleave loads of data from the selected first multiplication tile and the selected second multiplication tile, and execute a compiler that determines at least one of a size of the selected first multiplication tile, a size of the selected second multiplication tile, a size of the first groups or a size of the second groups.

Example 6 includes the computing system of any one of Examples 1 to 5, wherein the memory is a unified memory that stores the selected first multiplication tile, the selected second multiplication tile and an output of the plurality of matrix multiplication operations, and the accelerator is a systolic array.

Example 7 includes a semiconductor apparatus, the semiconductor apparatus comprising one or more substrates, and logic coupled to the one or more substrates, wherein the logic is implemented in one or more of configurable logic or fixed-functionality logic, the logic coupled to the one or more substrates to divide first data associated with a first matrix into first multiplication tiles based on a block size that is identified based on an available space of a memory of an accelerator, and second data associated with a second matrix into second multiplication tiles based on the block size, divide the first multiplication tiles into a plurality of first groups that correspond to a plurality of matrix multiplication operations and the second multiplication tiles into a plurality of second groups that correspond to the plurality of matrix multiplication operations, and load a selected first multiplication tile of the first multiplication tiles and a selected second multiplication tile of the second multiplication tiles into the memory to execute one or more of the plurality of matrix multiplication operations with selected groups of the plurality of first groups and the plurality of second groups.

Example 8 includes the apparatus of Example 7, wherein the logic coupled to the one or more substrates is further to identify an expected data input size of the accelerator, identify a first plurality of sub-tiles, wherein sizes of the first plurality of sub-tiles are the expected data input size, wherein the plurality of first groups includes the first plurality of sub-tiles, and identify a second plurality of sub-tiles, wherein sizes of the second plurality of sub-tiles are the expected data input size, wherein the plurality of second groups includes the second plurality of sub-tiles.

Example 9 includes the apparatus of Example 7, wherein each of the plurality of first groups includes data for one matrix multiplication operation of the plurality of matrix multiplication operations, each of the plurality of second groups includes data for one matrix multiplication operation of the plurality of matrix multiplication operations, and the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

Example 10 includes the apparatus of Example 9, wherein the logic coupled to the one or more substrates is further to allocate a second amount of the memory to pre-fetch data, store a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations, and store a second pre-fetch group of the plurality of second groups into the memory based on the second amount and while the accelerator executes the first matrix multiplication operation, wherein the second pre-fetch group is associated with the second matrix multiplication operation.

Example 11 includes the apparatus of any one of Examples 7 to 10, wherein the logic coupled to the one or more substrates is further to interleave loads of data from the selected first multiplication tile and the selected second multiplication tile, and execute a compiler that determines at least one of a size of the selected first multiplication tile, a size of the selected second multiplication tile, a size of the first groups or a size of the second groups.

Example 12 includes the apparatus of any one of Examples 7 to 11, wherein the memory is a unified memory that stores the selected first multiplication tile, the selected second multiplication tile and an output of the plurality of matrix multiplication operations, and the accelerator is a systolic array.

Example 13 includes the apparatus of any one of Examples 7 to 12, wherein the logic coupled to the one or more substrates includes transistor channel regions that are positioned within the one or more substrates.

Example 14 includes at least one computer readable storage medium comprising a set of executable program instructions, which when executed by a computing system, cause the computing system to divide first data associated with a first matrix into first multiplication tiles based on a block size that is identified based on an available space of a memory of an accelerator, and second data associated with a second matrix into second multiplication tiles based on the block size, divide the first multiplication tiles into a plurality of first groups that correspond to a plurality of matrix multiplication operations and the second multiplication tiles into a plurality of second groups that correspond to the plurality of matrix multiplication operations, and load a selected first multiplication tile of the first multiplication tiles and a selected second multiplication tile of the second multiplication tiles into the memory to execute one or more of the plurality of matrix multiplication operations with selected groups of the plurality of first groups and the plurality of second groups.

Example 15 includes the at least one computer readable storage medium of Example 14, wherein the instructions, when executed, further cause the computing system to identify an expected data input size of the accelerator, identify a first plurality of sub-tiles, wherein sizes of the first plurality of sub-tiles are the expected data input size, wherein the plurality of first groups includes the first plurality of sub-tiles, and identify a second plurality of sub-tiles, wherein sizes of the second plurality of sub-tiles are the expected data input size, wherein the plurality of second groups includes the second plurality of sub-tiles.

Example 16 includes the at least one computer readable storage medium of Example 14, wherein each of the plurality of first groups includes data for one matrix multiplication operation of the plurality of matrix multiplication operations, each of the plurality of second groups includes data for one matrix multiplication operation of the plurality of matrix multiplication operations, and the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

Example 17 includes the at least one computer readable storage medium of Example 16, wherein the instructions, when executed, further cause the computing system to allocate a second amount of the memory to pre-fetch data, store a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations, and store a second pre-fetch group of the plurality of second groups into the memory based on the second amount and while the accelerator executes the first matrix multiplication operation, wherein the second pre-fetch group is associated with the second matrix multiplication operation.

Example 18 includes the at least one computer readable storage medium of any one of Examples 14 to 17, wherein the instructions, when executed, further cause the computing system to interleave loads of data from the selected first multiplication tile and the selected second multiplication tile, and execute a compiler that determines at least one of a size of the selected first multiplication tile, a size of the selected second multiplication tile, a size of the first groups or a size of the second groups.

Example 19 includes the at least one computer readable storage medium of any one of Examples 14 to 18, wherein the memory is a unified memory that stores the selected first multiplication tile, the selected second multiplication tile and an output of the plurality of matrix multiplication operations, and the accelerator is a systolic array.

Example 20 includes a method comprising dividing first data associated with a first matrix into first multiplication tiles based on a block size that is identified based on an available space of a memory of an accelerator, and second data associated with a second matrix into second multiplication tiles based on the block size, dividing the first multiplication tiles into a plurality of first groups that correspond to a plurality of matrix multiplication operations and the second multiplication tiles into a plurality of second groups that correspond to the plurality of matrix multiplication operations, and loading a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

Example 21 includes the method of Example 20, further comprising identifying an expected data input size of the accelerator, identifying a first plurality of sub-tiles, wherein sizes of the first plurality of sub-tiles are the expected data input size, wherein the plurality of first groups includes the first plurality of sub-tiles, and identifying a second plurality of sub-tiles, wherein sizes of the second plurality of sub-tiles are the expected data input size, wherein the plurality of second groups includes the second plurality of sub-tiles.

Example 22 includes the method of Example 20, wherein each of the plurality of first groups includes data for one matrix multiplication operation of the plurality of matrix multiplication operations, each of the plurality of second groups includes data for one matrix multiplication operation of the plurality of matrix multiplication operations, and the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

Example 23 includes the method of Example 22, wherein the method further comprises allocating a second amount of the memory to pre-fetch data, storing a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations, and storing a second pre-fetch group of the plurality of second groups into the memory based on the second amount and while the accelerator executes the first matrix multiplication operation, wherein the second pre-fetch group is associated with the second matrix multiplication operation.

Example 24 includes the method of any one of Examples 20 to 23, wherein the method comprises interleaving loads of data from the selected first multiplication tile and the selected second multiplication tile, and executing a compiler that determines at least one of a size of the selected first multiplication tile, a size of the selected second multiplication tile, a size of the first groups or a size of the second groups.

Example 25 includes the method of any one of Examples 20 to 24, wherein the memory is a unified memory that stores the selected first multiplication tile, the selected second multiplication tile and an output of the plurality of matrix multiplication operations, and the accelerator is a systolic array.

Example 26 includes an apparatus comprising means for dividing first data associated with a first matrix into first multiplication tiles based on a block size that is identified based on an available space of a memory of an accelerator, and second data associated with a second matrix into second multiplication tiles based on the block size, means for dividing the first multiplication tiles into a plurality of first groups that correspond to a plurality of matrix multiplication operations and the second multiplication tiles into a plurality of second groups that correspond to the plurality of matrix multiplication operations, and means for loading a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

Example 27 includes the apparatus of Example 26, further comprising means for identifying an expected data input size of the accelerator, means for identifying a first plurality of sub-tiles, wherein sizes of the first plurality of sub-tiles are the expected data input size, wherein the plurality of first groups includes the first plurality of sub-tiles, and means for identifying a second plurality of sub-tiles, wherein sizes of the second plurality of sub-tiles are the expected data input size, wherein the plurality of second groups includes the second plurality of sub-tiles.

Example 28 includes the apparatus of Example 26, wherein each of the plurality of first groups includes data for one matrix multiplication operation of the plurality of matrix multiplication operations, each of the plurality of second groups includes data for one matrix multiplication operation of the plurality of matrix multiplication operations, and the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

Example 29 includes the apparatus of Example 28, wherein the method further comprises means for allocating a second amount of the memory to pre-fetch data, means for storing a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations, and storing a second pre-fetch group of the plurality of second groups into the memory based on the second amount and while the accelerator executes the first matrix multiplication operation, wherein the second pre-fetch group is associated with the second matrix multiplication operation.

Example 30 includes the apparatus of any one of Examples 26 to 29, wherein the method comprises means for interleaving loads of data from the selected first multiplication tile and the selected second multiplication tile, and means for executing a compiler that determines at least one of a size of the selected first multiplication tile, a size of the selected second multiplication tile, a size of the first groups or a size of the second groups.

Example 31 includes the apparatus of any one of Examples 26 to 30, wherein the memory is a unified memory that stores the selected first multiplication tile, the selected second multiplication tile and an output of the plurality of matrix multiplication operations, and the accelerator is a systolic array.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical, or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a data storage to store first data for a first matrix and second data for a second matrix;
an accelerator to perform a plurality of matrix multiplication operations and that includes a memory; and
a controller implemented in one or more of configurable logic or fixed-functionality logic, wherein the controller is to:
divide the first data into first multiplication tiles based on a block size that is identified based on an available space of the memory, and the second data into second multiplication tiles based on the block size,
divide the first multiplication tiles into a plurality of first groups that correspond to the plurality of matrix multiplication operations and the second multiplication tiles into a plurality of second groups that correspond to the plurality of matrix multiplication operations, and
load a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

2. The computing system of claim 1, wherein the controller is further to:
identify an expected data input size of the accelerator,
identify a first plurality of sub-tiles, wherein sizes of the first plurality of sub-tiles are the expected data input size, wherein the plurality of first groups includes the first plurality of sub-tiles; and
identify a second plurality of sub-tiles, wherein sizes of the second plurality of sub-tiles are the expected data input size, wherein the plurality of second groups includes the second plurality of sub-tiles.

3. The computing system of claim 1, wherein:
each of the plurality of first groups includes data for one matrix multiplication operation of the plurality of matrix multiplication operations;
each of the plurality of second groups includes data for one matrix multiplication operation of the plurality of matrix multiplication operations; and
the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

4. The computing system of claim 3, wherein the controller is further to:
allocate a second amount of the memory to pre-fetch data,
store a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations, and
store a second pre-fetch group of the plurality of second groups into the memory based on the second amount and while the accelerator executes the first matrix multiplication operation, wherein the second pre-fetch group is associated with the second matrix multiplication operation.

5. The computing system of claim 1, wherein the controller is further to:
interleave loads of data from the selected first multiplication tile and the selected second multiplication tile, and
execute a compiler that determines at least one of a size of the selected first multiplication tile, a size of the selected second multiplication tile, a size of the first groups or a size of the second groups.

6. The computing system of claim 1, wherein:
the memory is a unified memory that stores the selected first multiplication tile, the selected second multiplication tile and an output of the plurality of matrix multiplication operations; and
the accelerator is a systolic array.

7. A semiconductor apparatus, the semiconductor apparatus comprising:
one or more substrates; and
logic coupled to the one or more substrates, wherein the logic is implemented in one or more of configurable logic or fixed-functionality logic, the logic coupled to the one or more substrates to:
divide first data associated with a first matrix into first multiplication tiles based on a block size that is identified based on an available space of a memory of an accelerator, and second data associated with a second matrix into second multiplication tiles based on the block size;
divide the first multiplication tiles into a plurality of first groups that correspond to a plurality of matrix multiplication operations and the second multiplication tiles into a plurality of second groups that correspond to the plurality of matrix multiplication operations; and
load a selected first multiplication tile of the first multiplication tiles and a selected second multiplication tile of the second multiplication tiles into the memory to execute one or more of the plurality of matrix multiplication operations with selected groups of the plurality of first groups and the plurality of second groups.

8. The apparatus of claim 7, wherein the logic coupled to the one or more substrates is further to:
identify an expected data input size of the accelerator;
identify a first plurality of sub-tiles, wherein sizes of the first plurality of sub-tiles are the expected data input size, wherein the plurality of first groups includes the first plurality of sub-tiles; and
identify a second plurality of sub-tiles, wherein sizes of the second plurality of sub-tiles are the expected data input size, wherein the plurality of second groups includes the second plurality of sub-tiles.

9. The apparatus of claim 7, wherein:
each of the plurality of first groups includes data for one matrix multiplication operation of the plurality of matrix multiplication operations;
each of the plurality of second groups includes data for one matrix multiplication operation of the plurality of matrix multiplication operations; and
the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

10. The apparatus of claim 9, wherein the logic coupled to the one or more substrates is further to:
allocate a second amount of the memory to pre-fetch data;
store a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations; and
store a second pre-fetch group of the plurality of second groups into the memory based on the second amount and while the accelerator executes the first matrix multiplication operation, wherein the second pre-fetch group is associated with the second matrix multiplication operation.

11. The apparatus of claim 7, wherein the logic coupled to the one or more substrates is further to:
interleave loads of data from the selected first multiplication tile and the selected second multiplication tile; and
execute a compiler that determines at least one of a size of the selected first multiplication tile, a size of the selected second multiplication tile, a size of the first groups or a size of the second groups.

12. The apparatus of claim 7, wherein:
the memory is a unified memory that stores the selected first multiplication tile, the selected second multiplication tile and an output of the plurality of matrix multiplication operations; and
the accelerator is a systolic array.

13. The apparatus of claim 7, wherein the logic coupled to the one or more substrates includes transistor channel regions that are positioned within the one or more substrates.

14. At least one computer readable storage medium comprising a set of executable program instructions, which when executed by a computing system, cause the computing system to:
divide first data associated with a first matrix into first multiplication tiles based on a block size that is identified based on an available space of a memory of an accelerator, and second data associated with a second matrix into second multiplication tiles based on the block size;
divide the first multiplication tiles into a plurality of first groups that correspond to a plurality of matrix multiplication operations and the second multiplication tiles into a plurality of second groups that correspond to the plurality of matrix multiplication operations; and
load a selected first multiplication tile of the first multiplication tiles and a selected second multiplication tile of the second multiplication tiles into the memory to execute one or more of the plurality of matrix multiplication operations with selected groups of the plurality of first groups and the plurality of second groups.

15. The at least one computer readable storage medium of claim 14, wherein the instructions, when executed, further cause the computing system to:
identify an expected data input size of the accelerator;
identify a first plurality of sub-tiles, wherein sizes of the first plurality of sub-tiles are the expected data input size, wherein the plurality of first groups includes the first plurality of sub-tiles; and
identify a second plurality of sub-tiles, wherein sizes of the second plurality of sub-tiles are the expected data input size, wherein the plurality of second groups includes the second plurality of sub-tiles.

16. The at least one computer readable storage medium of claim 14, wherein:
each of the plurality of first groups includes data for one matrix multiplication operation of the plurality of matrix multiplication operations;
each of the plurality of second groups includes data for one matrix multiplication operation of the plurality of matrix multiplication operations; and
the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

17. The at least one computer readable storage medium of claim 16, wherein the instructions, when executed, further cause the computing system to:
allocate a second amount of the memory to pre-fetch data;
store a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations; and
store a second pre-fetch group of the plurality of second groups into the memory based on the second amount and while the accelerator executes the first matrix multiplication operation, wherein the second pre-fetch group is associated with the second matrix multiplication operation.

18. The at least one computer readable storage medium of claim 14, wherein the instructions, when executed, further cause the computing system to:
interleave loads of data from the selected first multiplication tile and the selected second multiplication tile; and
execute a compiler that determines at least one of a size of the selected first multiplication tile, a size of the selected second multiplication tile, a size of the first groups or a size of the second groups.

19. The at least one computer readable storage medium of claim 14, wherein:
the memory is a unified memory that stores the selected first multiplication tile, the selected second multiplication tile and an output of the plurality of matrix multiplication operations; and
the accelerator is a systolic array.

20. A method comprising:
dividing first data associated with a first matrix into first multiplication tiles based on a block size that is identified based on an available space of a memory of an accelerator, and second data associated with a second matrix into second multiplication tiles based on the block size;
dividing the first multiplication tiles into a plurality of first groups that correspond to a plurality of matrix multiplication operations and the second multiplication tiles into a plurality of second groups that correspond to the plurality of matrix multiplication operations; and
loading a selected first multiplication tile of the first multiplication tiles and a selected second multiplication tile of the second multiplication tiles into the memory to execute one or more of the plurality of matrix multiplication operations with selected groups of the first plurality of groups and the second plurality of groups.

21. The method of claim 20, further comprising:
identifying an expected data input size of the accelerator;
identifying a first plurality of sub-tiles, wherein sizes of the first plurality of sub-tiles are the expected data input size, wherein the plurality of first groups includes the first plurality of sub-tiles; and
identifying a second plurality of sub-tiles, wherein sizes of the second plurality of sub-tiles are the expected data input size, wherein the plurality of second groups includes the second plurality of sub-tiles.

22. The method of claim 20, wherein:
each of the plurality of first groups includes data for one matrix multiplication operation of the plurality of matrix multiplication operations;
each of the plurality of second groups includes data for one matrix multiplication operation of the plurality of matrix multiplication operations; and
the selected first multiplication tile includes a first matrix multiplication group of the plurality of first groups, and the selected second multiplication tile includes a second matrix multiplication group of the plurality of second groups, the first matrix multiplication group and the second matrix multiplication group including input data to execute a first matrix multiplication operation of the plurality of matrix multiplication operations.

23. The method of claim 22, wherein the method further comprises:
allocating a second amount of the memory to pre-fetch data;
storing a first pre-fetch group of the plurality of first groups into the memory based on the second amount and while the accelerator executes a first matrix multiplication operation of the plurality of matrix multiplication operations, wherein the first pre-fetch group is associated with a second matrix multiplication operation of the plurality of matrix multiplication operations; and
storing a second pre-fetch group of the plurality of second groups into the memory based on the second amount and while the accelerator executes the first matrix multiplication operation, wherein the second pre-fetch group is associated with the second matrix multiplication operation.

24. The method of claim 20, wherein the method comprises:
interleaving loads of data from the selected first multiplication tile and the selected second multiplication tile; and
executing a compiler that determines at least one of a size of the selected first multiplication tile, a size of the selected second multiplication tile, a size of the first groups or a size of the second groups.

25. The method of claim 20, wherein:
the memory is a unified memory that stores the selected first multiplication tile, the selected second multiplication tile and an output of the plurality of matrix multiplication operations; and
the accelerator is a systolic array.
